(19) United States
(12) Patent Application Publication
(10) Pub. No.: US 2013/0145283 A1
(43) Pub. Date: Jun. 6, 2013

(54) Automated Patent Event Notification System

(71) Applicant: Wei-Yeh Lee, New York, NY (US)

(72) Inventor: Wei-Yeh Lee, New York, NY (US)

(21) Appl. No.: 13/705,268

(22) Filed: Dec. 5, 2012

Related U.S. Application Data
(60) Provisional application No. 61/567,597, filed on Dec. 6, 2011.

(51) Int. Cl. H04L 12/58; G06F 3/0484

(52) U.S. Cl. CPC H04L 51/00; G06F 3/0484
USPC 715/752

(57) ABSTRACT

Systems, methods and computer program products for an automatic patent event notification are disclosed. In an aspect of the present invention, an automated patent event notification system enables an entity to select and to configure a class (or classes) of one or more patents (or one or more patent applications) and/or a family (or families) of one or more patents (or one or more patent applications) that are of interest to that the entity or that the entity is interested in monitoring. The system provides an event notification to the entity if a patent application of interest is published or a patent of interest is granted.

### CROSS REFERENCE TO RELATED APPLICATIONS

This Application claims the benefit of U.S. Provisional Patent Application No. 61/567,597, titled “Automated Patent Event Notification System,” filed on Dec. 6, 2011 (Atty. Docket No. 2194.02), which is incorporated by reference herein in its entirety.

This Application is related to commonly-owned U.S. patent application Ser. No. No. 13/561,129, titled “Aggregate Crowdsourcing Platforms,” filed on Jul. 30, 2012 (Atty. Docket No. 2194.04), which is incorporated by reference herein in its entirety.

### BACKGROUND OF THE INVENTION

1. Field of the Invention

The present invention generally relates to patent management functions, and more particularly to systems, methods and computer program products for an automated patent event notification system.

2. Related Art

Systems that use crowdsourcing typically use open calls in order to request solutions (or answers) to tasks (i.e., contests). The crowdsourcer will send the open call that will be directed to one or more communities (i.e., “crowds”). The open calls are typically made through, for example, web-based technologies such as, for example, web services. The crowdsourcing systems typically provide, in the open calls, the information describing the tasks and any other condition or constraint such as, for example, deadlines, non-disclosure agreements, rewards and/or other parameters. These tasks are typically traditionally performed by employees, contractors, consultants and/or the like. A task can be, for example, product design questions, business plan questions, advertising or marketing questions, or any other suitable question. Therefore, a crowdsourcing system allows the crowdsourcer to be a provider of contests, competitions, or tasks for communities, and the communities can then engage in competition among the community's individual members for the winning solution or valuable answer for the contest, competition, or task.

Crowdsourcing has become popular with businesses, organizations, schools and universities, authors, journalists and other entities as a method to leverage the ability of many individuals to collaborate as a community through wide-area networks such as, for example, the Internet and web-based technologies. In crowdsourcing, the crowdsourcer will own the best solution provided by an individual in a community (or provided by a community) to a task, and the winning individuals in the crowd are sometimes rewarded as permitted by the crowdsourcer. A winning individual (or individuals) can be rewarded by, for example, monetary compensation, prizes, recognition and/or other forms of compensation as set by the crowdsourcer.

Crowdsourcing systems are currently being used by some communities in order to exchange or share patent related publications. For example, ARTICLE ONE PARTNERS, LLC (http://www.articleonepartners.com/) is an online prior art search crowdsourced community where a patent (that the requestor seeks to invalidate) is posted online as a request for relevant research submissions, and rewards are paid to researchers based on the quality of the submissions. As another example, the crowdsourced platform CROWDIPR (http://www.crowdipr.com/) connects technology experts with companies that need patent and technology search. Although crowdsourcing systems are described herein for background information, an aspect of the invention to be discussed below does not necessarily require any crowdsourcing system, does not necessarily use any crowdsourcing method, and/or is not necessarily included in a crowdsourcing system or crowdsourcing platform.

With the America Invents Act (AIA) being signed into law in the United States of America on Sep. 16, 2011, there is a new industry need for notifications to a particular entity (e.g., a company, an individual or individuals, a partnership, a governmental entity, a non-profit organization, or another type of entity) whenever a patent(s) of interest to that particular entity is granted (i.e., issued). Such notifications will allow the notified particular entity to take any appropriate action on the newly-granted patent(s) of interest, by or before the 9-month Post-Grant Petition deadline under the AIA. The notified entity may then take an action such as, for example, buying, licensing or cross-licensing the patent(s), challenging the validity of the patent(s) through a Post-Grant Petition, requesting a third party to challenge the validity of the patent(s), entering into an agreement that involves a challenge by a third party to the validity of the patent(s), and/or performing other appropriate actions. A notification to any entity about the publication of any patent application(s) may also benefit the entity.

Before the AIA was signed into law, the Post-Grant Petition to challenge the validity of a newly-granted patent was not available under United States patent law. With the recent changes in patent law, there is now a need for an entity to foresee future potential conflicts with regard to the entity's intellectual property portfolios (including patent, patent application, invention, and/or technology portfolios), and with regard to the entity's current and future products so as to minimize potential infringement issues.

The current technology does not provide crowdsourcing systems with patent management functions that can notify a particular entity of events relating to a grant of a patent of interest to that particular entity or events relating to a publication of a patent application of interest to that particular entity. The current technology also does not provide any system or method for crowdsourcing systems to dynamically connect and notify any entity or entities having a similar interest in a newly-granted patent or having a similar interest in a newly-published patent application.

Given the foregoing, systems, methods and computer program products for automatic notifications of patent events (e.g., a grant of a patent or a publication of a patent application) are needed.

### BRIEF DESCRIPTION OF THE INVENTION

This summary is provided to introduce a selection of concepts. These concepts are further described below in the Detailed Description. This summary is not intended to identify key features or essential features to be claimed, nor is this summary intended as an aid in determining the scope of what will be claimed.

The present invention meets the above-identified needs by providing systems, methods and computer program products for patent management functions.

In an aspect of the invention, an automated patent event notification system (or “A-PENS”) provides an automatic notification of an event relating to a selected class or family of patents or patent applications.

In another aspect of the invention, an automatic patent event notification system may be included in a crowdsourcing system.

In yet another aspect of the invention, an automated patent event notification system enables an entity to select and to configure a class (or classes) of one or more patents (or one or more patent applications) and/or a family (or families) of one or more patents (or one or more patent applications) that are of interest to that the entity or that the entity is interested in monitoring. An entity can be, for example, a company, an individual or individuals, a partnership, an agency, a governmental entity, a non-profit organization, another type of entity, and/or a user associated with that particular entity. The system provides an event notification to the entity if a patent application of interest is published or a patent of interest is granted.

In yet another aspect of the invention, such automatic notifications will allow the notified particular entity to take any appropriate action on one or more newly-granted patents of interest, by or before the, for example, 9-month Post-Grant Petition deadline under the AIA. The notified entity can take an action such as, for example, buying, licensing or cross-licensing the patent(s), challenging the validity of the patent(s) through the Post-Grant Petition, requesting a third party to challenge the validity of the patent(s), entering into an agreement that involves a challenge by a third party to the validity of the patent(s), and/or performing other appropriate actions.

In yet another aspect of the invention, an automatic patent event notification system may be included in a crowdsourcing platform so that the system can dynamically connect and notify any entity or entities having a similar interest in one or more newly-granted patents or published patent applications regarding “patent events” which can be, for example, a grant of a patent, a publication of a patent application, or another event relating to a patent or patent application.

In yet another aspect of the invention, an automatic patent event notification system includes a monitoring adapter interface that enables developers to create a new corresponding patent notification code for each new data source (storing particular patents or patent applications) that becomes available to the public in general.

In yet another aspect of the invention, an automatic patent event notification system includes a patent matching notification application program interface (API) that enables developers to create new notifications mechanisms as new notification devices, modules, and/or methods become available to consumers or the public in general.

Further features and advantages of the present invention, as well as the structure and operation of various aspects of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary system and method for an automated notification of a patent event according to an aspect of the present invention.

FIG. 2 is a block diagram that shows additional details of an automated patent event notification system according to an aspect of the present invention.

FIG. 3 is a block diagram of a rule according to an aspect of the present invention.

FIG. 4 is a block diagram of a one field value according to an aspect of the present invention.

FIG. 5 is a block diagram of a rule set according to an aspect of the present invention.

FIG. 6 is a block diagram of a pattern according to an aspect of the present invention.

FIG. 7 is a block diagram of a rule event stage pattern according to an aspect of the present invention.

FIG. 8 is a block diagram of a first set of key monitorable dates that are monitored according to an aspect of the present invention.

FIG. 9 is a block diagram of a second set of key monitorable dates that are monitored according to an aspect of the present invention.

FIG. 10 is a flow diagram of an exemplary method for facilitating an automated patent event notification, according to an aspect of the present invention.

FIG. 11 is a block diagram of an exemplary computer system useful for implementing an aspect of the present invention.

### DETAILED DESCRIPTION

The present invention is directed to systems, methods and computer program products for patent management functions.

In an aspect of the invention, an automated patent event notification system (or A-PENS) provides an automatic notification of an event relating to a selected class or family of patents or patent applications.

In another aspect of the invention, an automatic patent event notification system may be included in a crowdsourcing system.

In yet another aspect of the invention, an automated patent event notification system enables an entity to select and to configure a class (or classes) of one or more patents (or one or more patent applications) and/or a family (or families) of one or more patents (or one or more patent applications) that are of interest to that the entity or that the entity is interested in monitoring. An entity can be, for example, a company, an individual or individuals, a partnership, an agency, a governmental entity, a non-profit organization, another type of entity, and/or a user associated with any such particular entities. The system provides an event notification to the entity if a patent application of interest is published or a patent of interest is granted.

In yet another aspect of the invention, such automatic notifications will allow the notified particular entity to take any appropriate action on one or more newly-granted patents of interest, by or before the, for example, 9-month Post-Grant Petition process of the AIA deadline under the AIA. The notified entity can take an action such as, for example, buying, licensing or cross-licensing the patent(s), challenging the validity of the patent(s) through the Post-Grant Petition, requesting a third party to challenge the validity of the patent(s), entering into an agreement that involves a challenge by a third party to the validity of the patent(s), and/or performing other appropriate actions.

In yet another aspect of the invention, an automatic patent event notification system may be included in a crowdsourcing platform so that the system can dynamically connect and notify any entity or entities having a similar interest in one or more newly-granted patents or published patent applications regarding “patent events” which can be, for example, a grant of a patent, a publication of a patent application, or another event relating to a patent or patent application.

In yet another aspect of the invention, an automatic patent event notification system includes a monitoring adapter interface that enables developers to create a new corresponding patent notification code for each new data source (storing particular patents or patent applications) that becomes available to the public in general.

In yet another aspect of the invention, an automatic patent event notification system includes a patent matching notification application program interface (API) that enables developers to create new notifications mechanisms as new notification devices, modules, and/or methods become available to consumers or the public in general.

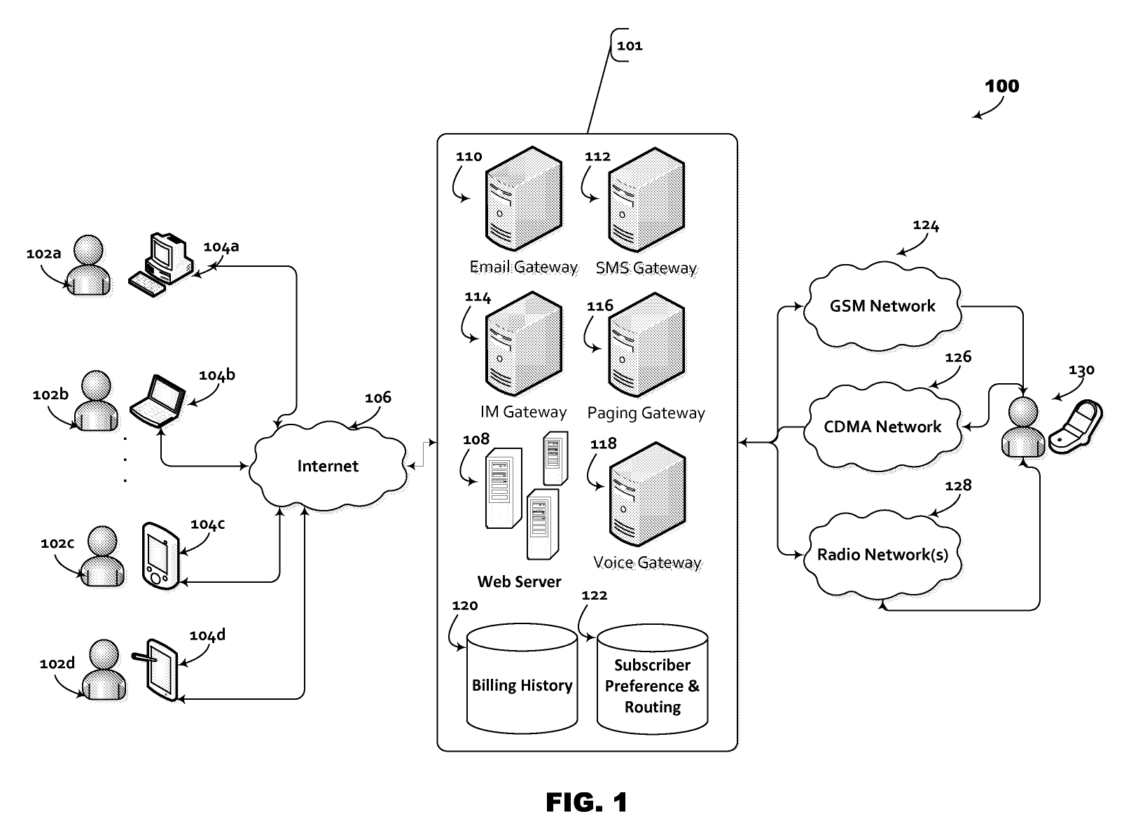

Referring to FIG. 1, a block diagram illustrating an exemplary communication system 100, according to an aspect of the present invention, is shown. The system 100 includes a plurality of individuals 102 (shown as users 102a-d in FIG. 1) accessing, via a computing device 104 (shown as respective computing devices 104a-d in FIG. 1), a communications network 106, such as, for example, the global, public Internet. The individuals 102 can use the computing devices 104 to form a community (or community platform) that belongs in a crowdsourcing system. The computing devices 104 communicate via network 106 to a communication infrastructure 101 that allows the methods or operations discussed below. The hardware and software components in the infrastructure 101 are typically all communicatively coupled together.

In one aspect of the invention, individuals 102 (when using their respective devices 104) may form a community if a crowdsourcing function is included in communications system 100. In another aspect of the invention, a crowdsourcing function is not required or is omitted in communications system 100.

In various aspects, computing device 104 may be configured as a desktop computer 104a, a laptop computer 104b, a personal digital assistant (PDA) 104c, a tablet or mobile computer 104d, any commercially-available intelligent communications device, or the like. The computing devices 104 can be other types of devices that are not shown in FIG. 1 such as, for example, a television with Internet browsing capability or other suitable types of devices.

As shown in FIG. 1, in an aspect of the present invention, the infrastructure 101 may be connected to one or more telecommunications networks such as a GSM network 124, a CDMA network 126, a radio network 128 or the like. Such networks 124-128 would allow communication between the infrastructure 101 and one or more devices 104e which can be, for example, a mobile telephone that can communicate via the Internet or other wide-area networks.

As will also be appreciated by those skilled in the relevant art(s), in an aspect, various (login, admin, account, information, resource, logout, payment, registration, communications and/or the like) screens would be generated by a server 108 (in the infrastructure 101) in response to input from users 102 over network 106. That is, in such an aspect, server 108 is a typical Web server running a server application at a Web site which sends out Web pages in response to Hypertext Transfer Protocol (HTTP) or Hypertext Transfer Protocol Secured (HTTPS) requests from remote browsers in various devices 104 being used by various users 102. Thus, server 108 is able to provide a graphical user interface (GUI) to users 102 of system 100 in the form of Web pages. These Web pages sent to the user's PC, laptop, mobile device, PDA, mobile phone, or the like device 104, and would result in the GUI being displayed.

Various data such as, for example, login and/or account information of participants in a community, can be stored in a database 120 that is accessible by the web server 108. In another aspect, the various data can be stored in a memory included in (or coupled to) the web server 108.

In another aspect, the infrastructure 101 may also include a text PBX server 109, an email gateway server 110, an SMS gateway server 112, an instant message (IM) gateway server 114, a paging gateway server 116 and/or a voice gateway server 118 for allowing other forms of communication to be supported by systems that function in the infrastructure 101.

In an aspect of the invention, web server 108 is arranged to store, support, operate and/or execute one or more automated patent event notification systems (A-PENS) 130 to be discussed below. In an aspect, A-PENS 130 permits the functions and operations to be discussed in detail below.

In an aspect of the invention, web server 108 may be arranged to store, support, operate and/or execute at least one crowdsourcing system 131 with crowdsourcing functions that have been described above and/or that are known to those skilled in the relevant art(s). In an aspect of the invention with a crowdsourcing function, the crowdsourcer may be different for each A-PENS 130, or a crowdsourcer can use a plurality of A-PENS 130, or a combination of both. In an aspect of the invention with a crowdsourcing function, the crowdsourcer may be different for each crowdsourcing system 131, or a crowdsourcer can use multiple crowdsourcing systems 131, or a combination of both.

As will also be appreciated by those skilled in the relevant art(s) after reading the description herein, alternate aspects of the present invention may include providing the tool for facilitating the automated patent event notification system (e.g., installed on one PC) or as an enterprise system wherein all the components of infrastructure 101 are connected and communicate via an inter-corporate wide area network (WAN) or local area network (LAN), rather than as a Web service (i.e., application service provider (ASP) model) as shown in FIG. 1.

In an aspect of the invention, one or more A-PENS 130 can be included in other communication systems that is different from or that vary in one or more features from communication system 100.

In an aspect of the invention, A-PENS 130 permits a user to enter a profile and to also automatically receive a notice of a grant of any patent(s) that the user has indicated as a patent(s) of interest, and/or to automatically receive a notice of a publication of any patent application(s) that the user has indicated as a patent application(s) of interest.

For simplicity of discussion, a “published patent document” as discussed herein may be a granted patent, a published patent application, a published Patent Cooperation Treaty (PCT) application, a published abstract or another published patent application related document that is limited in description, and/or another type of publicly-available document associated with a patent or patent application published by WIPO or any jurisdictional or regional patent office.

The profile entered by the user may also identify a family or families of patents or patent applications that the user has identified as of an interest to the user or entity associated with the user, a class or classes of patents or patent applications that the user has identified as of an interest to the user or entity associated with the user, a company name, or another information or value. Therefore, A-PENS 130 enables an entity to select and to configure a class (or classes) of patents (or patent applications) and/or a family (or families) of patents (or patent applications) that is of interest to that entity and that the entity is interested in monitoring, and A-PENS 130 will automatically notify the entity if any patent(s) of interest is granted or if any patent application(s) of interest is published. As mentioned above, an entity can be, for example, a company, an individual or individuals, a partnership, an agency, a governmental entity, a non-profit organization, or another type of entity, or a user associated with that entity. A-PENS 130 provides an event notification to entity 102 if a patent application of interest is published or a patent of interest is granted.

An automatic notification will allow the notified particular entity to take any appropriate action on one or more newly-granted patents of interest, by or before the 9-month Post-Grant Petition deadline under the AIA. As mentioned above, the notified entity can take an action such as, for example, buying, licensing or cross-licensing the patent(s), challenging the validity of the patent(s) through the Post-Grant Petition, requesting a third party to challenge the validity of the patent(s), entering into an agreement that involves a challenge by a third-party to the validity of the patent(s), and/or performing other appropriate actions.

Before the AIA was signed into law, the Post-Grant Petition to challenge a newly-granted patent was not available under United States patent law. With recent changes in patent law, A-PENS 130 allows an entity to benefit as follows: (1) the entity receives a notification on a grant of any patent(s) (or a publication of any patent application(s)) of interest to that entity, (2) the entity can now foresee future potential conflicts with regard to the entity's intellectual property portfolios (including patent, patent application, invention, and/or technology portfolios) and with regard to the entity's current and future products so as to minimize potential infringement issues, and (3) the entity can respond to the grant of a patent(s) (or the publication of a patent application(s)) of interest by buying, licensing or cross-licensing the patent or patent application, challenging the validity of the patent through the Post-Grant Petition, and/or performing other appropriate actions as mentioned above and including not taking any actions if the granted patent(s) (or published patent application(s)) is deemed to pose a minimal problem or no potential problem to the entity. Other potential uses include monitoring competitor patent portfolios and monitoring the direction that a particular industry or technology space is moving.

In an aspect of the invention, A-PENS 130 can be used in a crowdsourcing system with patent management functions, and A-PENS 130 can notify a particular entity of events such as the grant of one or more patents of interest to that particular entity or a publication of one or more patent applications of interest to that particular entity. In another aspect of the invention, A-PENS 130 is not included in a crowdsourcing system.

In another aspect of the invention, A-PENS 130 can be used with crowdsourcing system 131 so that A-PENS 130 can dynamically connect and notify any entity or entities having an interest in one or more newly-granted patents or published patent applications regarding “patent events” which can be, for example, a grant of a patent, a publication of a patent application, or another event relating to a patent or patent application.

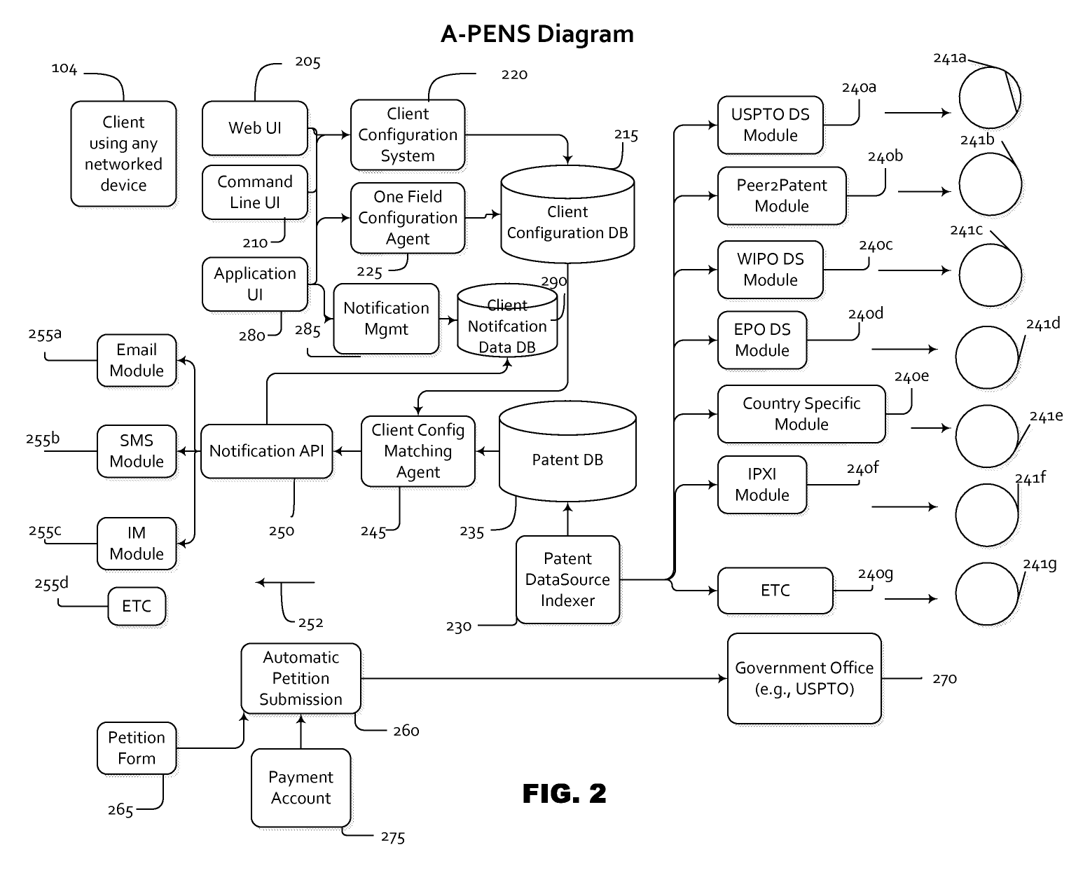

FIG. 2 is a block diagram that shows additional details of an automated patent event notification system 130 (i.e., A-PENS 130) according to an aspect of the present invention. A-PENS 130 can perform or allow at least one or more functions in the above-described aspects of the invention. The functions or operations that are performed by A-PENS 130 can be programmed by, for example, the use of a suitable software programming language as known to those skilled in the relevant art(s). In an aspect, A-PENS 130 include various modules, systems, or subsystems as shown in some of the block components in FIG. 2. It is understood that the exemplary modules, systems, or subsystems in FIG. 2 to be discussed below can be integrated together in functionalities into one or more modules or combinations of modules. However, for purposes of clarity of discussion of aspects of the invention, particular modules, systems, and subsystems or particular systems/subsystems are shown in FIG. 2 as separate block components. Therefore, the exemplary block components in FIG. 2 can be varied in functionalities and can be integrated together into one or more block components.

It is also understood that A-PENS 130 can be separate modules that can be configured differently. For example, some of the modules in A-PENS 130 can be located in the client-side (e.g., in client devices 104), while other modules in A-PENS 130 can be located in the server-side (e.g., in server 108). Other configurations of the locations of A-PENS 130 are also possible.

In an aspect of the invention, A-PENS 130 includes at least one of the following components that will be discussed in detail below: web user interface 205; command line user interface 210; client configuration database 215; client configuration system 220; one field configuration agent 225; notification management 285; patent data source indexer 230; client notification data database 290; patent database 235; data store (DS) modules 240 such as, for example, USPTO (U.S. Patent and Trademark Office) data store module 240a, Peer2Patent data store module 240b, WIPO (World Intellectual Property Organization) data store module 240c, EPO (European Patent Office) data store module 240d, one or more country specific data store module(s) 240e (e.g., Japan Patent Office DS module, Taiwan Intellectual Property Office DS module, China Intellectual Property Office DS module, or other country-specific DS modules), IPXI (intellectual property exchange) DS module 240f, and/or other data store modules 240g; client configuration matching agent 245; notification application program interface (API) 250; and notification module(s) 255 (e.g., electronic mail (Email) module 255a, short message service (SMS) module 255b; instant messaging (IM) module 255c; and/or other modules 255d) for providing a notification mechanism and/or notification method.

One or more client devices 104 are configured to communicate with A-PENS 130 via network 106. In one aspect of the invention, A-PENS 130 includes a web user interface (web UI) 205 and/or a command line user interface (command line UI) 210. In yet another aspect of the invention, one of web UI 205 or command line UI 210 may be omitted in A-PENS 130.

In an aspect of the invention, any one of web UI 205 and/or command line UI 210 and/or Application UI 280 are typically located in a client device 104 (i.e., web UI 205 and/or command line UI 201 are in a client-side configuration and/or Application UI 280). In another aspect of the invention, any one of web UI 205 and/or command line UI 210 are located in server 108 (i.e., web UI 205 and/or command line UI 201 are in a server-side configuration). In still yet another aspect of the invention, any one of web UI 205 or command line UI 210 is located in server 108 while another one of web UI 205 or command line UI 210 or Application UI 280 are located in a client device 104. In an aspect, web UI 205 and/or command line UI 201 is a graphical user interface (GUI) or another type of user interface.

Web UI 205 and command line UI 210 and Application UI 280 are configured to display content and allow input of content from a user 102. Any one of web UI 205 and/or command line UI 210 and/or Application UI 280 is configured to receive one or more rule sets (or data) from a client device 104. A user 102 enters (or inputs) the rule set(s) into client device 104 where each rule set enables a user 102 to select and configure (into A-PENS 130) one or more families of patent(s) or patent application(s) and/or one or more classes of patent(s) or patent application(s) of interest to user 102 (or an entity) or that the user 102 (or entity) desires to monitor. Because an entity may be associated with a user 102, an entity 102 can also be the same as a user 102 in FIG. 1 for the sake of simplicity. In an aspect, a user 102 can input the rule set(s) into interfaces 205 and/or 210 and/or Application UI 280 by clicking on selections in interfaces 205 and/or 210 and/or Application UI 280 and/or by creating one or more rule sets and adding the one or more rule sets into a client profile in a client user database 215. The rule sets are discussed further below.

A-PENS 130 will compare the rule sets in each client profile to determine if there is any match with a patent that is granted (or a patent application that is published) by a patent office or patent data store (e.g., USPTO, EPO, WIPO, or the like) being monitored by A-PENS 130 with any family or families of patent(s) or patent application(s), and/or class or classes of patent(s) or patent application(s) of interest to user 102 and selected by user 102.

In an aspect of the invention, a client configuration module (system) 220 is configured to receive the rule set(s) from web UI 205 or command line UI 201, and is configured to add the rule set(s) to a client profile in client configuration database 215. Each client profile in database 215 corresponds to a particular entity 102. Therefore, database 215 typically stores more than one client profile, with each client profile corresponding to an associated entity.

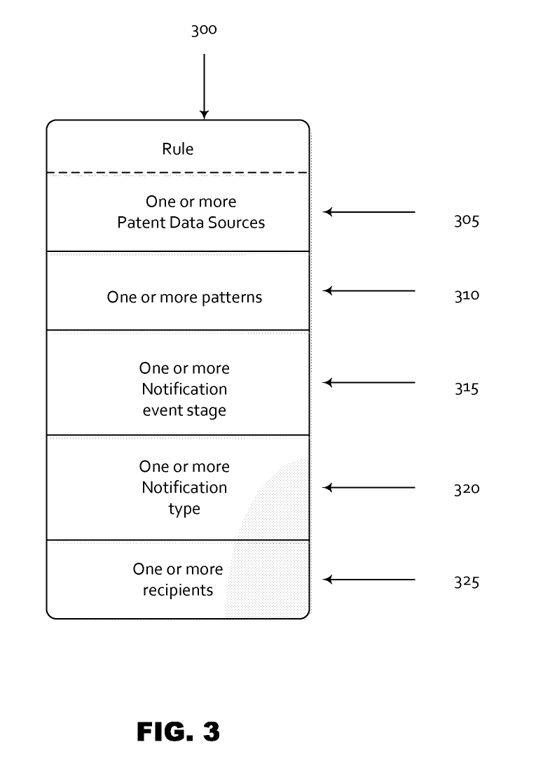

In an aspect, client configuration module 220 is configured to enable a user 102 to use a web UI 205 or command line UI 210 to configure one or more rule sets. In an aspect, a rule set can include one or more rules. Exemplary rules in a rule set will be discussed below with reference to FIG. 3.

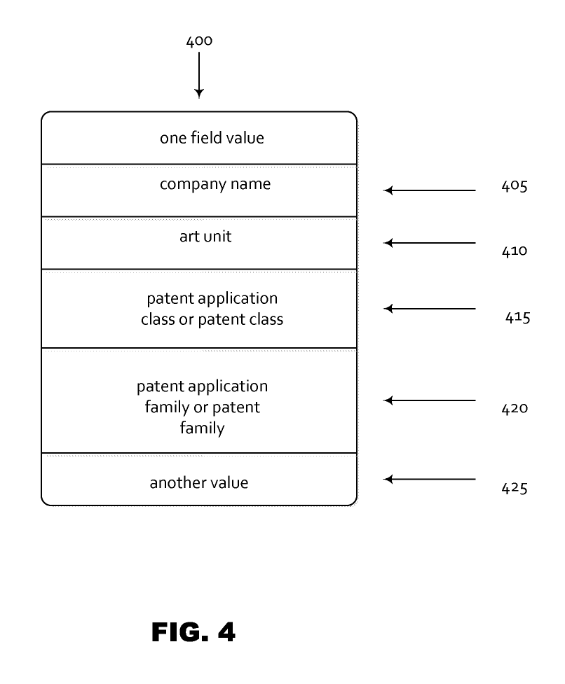

In an aspect of the invention, a one field configuration agent 225 is configured to receive a one field value from web UI 205 or command line UI 210 or application UI 280 and is configured to add the one field value to a client profile in client configuration database 215. This one field value is entered by a user 102 into client device 104. Exemplary values or parameters that could be used as a one field value is further discussed with reference to FIG. 4. For example, a user 102 can enter the name of an entity (e.g., name of company) associated with user 102. Agent 225 will receive and store the one field value in a client profile in client configuration database 215. This example is discussed further below.

A patent data source indexer 230 is configured to store published patent applications or granted patents and any associated patent information (e.g., bibliographic references, etc.) in a patent database 235. Indexer 230 can determine patent applications that are published and patents that are granted when configuration modules 240 track the patent applications (or other documents associated with patent applications) that are published or patents that are granted in the respective data stores 241 (e.g., patent offices) that configuration modules 240 are interfaced with. In other words, configuration modules 240 are monitoring adapter interfaces that provide notifications to indexer 230 when a patent application (or document associated with a patent application) is published or a patent is granted in an associated data store 241.

In an aspect, data source indexer 230 is a developer API that enables code developers to write new codes for new data sources containing patent applications and related publications and patents. Indexer 230 communicates with configuration modules 240 having APIs that enable modules 240 to communicate with new types of data stores 241 that are implemented in the future.

In an aspect of the invention, configuration modules 240 is configured to connect and access one or more of the following exemplary data stores 241 and indexer 230 is configured to index the contents (e.g., patent applications, documents associated with patent applications, patent abstracts, patents and/or the like) in the data stores 241: Peer2Patent (http://peertopatent.org/), patents.google.com, U.S. Patent and Trademark Office or USPTO (including EFS, PPH, and/or the like), European Patent Office (EPO), World Intellectual Property Organization (WIPO), each country's Patent Office that are available online, ArticleOne (including available patent busting contests), IPXI (including patents available for sale or licensing), ICAP (http://icappatentbrokerage.com), The IPZone (http://www.ipzone.com), CROWDIPR, and/or other data stores available to the public.

In an aspect, indexer 230 and configuration modules 240 may be optimized so that modules 240 may perform prefetching of content in the data sources and indexer 230 performs indexing of the prefetched content from the data stores 241. Modules 240 may use data prefetching methods known to those skilled in the relevant art(s).

In an aspect, indexer 230 may optimize the storage of content into patent database 235 by indexing and referencing the original documents obtained from the data stores 241. In an aspect, indexer 230 may index content in, for example, a canonical index format and may have any of the following formats: International Common and Element (ICE) Red Book for Patent Grant Data/XML and Patent Application Data/XML, HTML, Text, PDF, and/or other formats. Indexer 230 will store into patent database 235 any viewable patent documents such as, for example, published patent applications, published documents associated with patent applications or patents (e.g., patent abstracts) and/or granted patents that are monitored by modules 240.

An exemplary A-PENS 130 includes at least one or more of the following modules 240: USPTO data store module 240a, Peer2Patent data store module 240b, WIPO data store module 240c, EPO data store module 240d, one or more country specific data store module(s) 240e, IPXI DS module 240f, and/or other data store modules 240g that are configured to interface with the USPTO data store 241a, Peer2Patent data store 241b, WIPO data store 241c, EPO data store 241d, one or more country specific data store(s) 241e (e.g., Japan Patent Office data store, Taiwan Intellectual Property Office data store, China Intellectual Property Office data store, or other country-specific patent data store), IPXI data store 241f, and/or other data store modules 241g, respectively. In an aspect of the invention, any of modules 240 may be omitted if it is desirable to deploy an A-PENS 130 that will be focused on monitoring only a specific type of patent applications or patents (e.g., U.S. patent applications or patents). Other modules 240g may be included in A-PENS 130 to interface with other data stores as listed above (e.g., patents.google.com, Article One, ICAP, CROWDIPR, and/or IPZone) in addition to data stores 241 in FIG. 2 or to interface with other data stores that are developed.

Module 240b is configured to interface with the Peer2Patent data store which permits individuals to upload prior art references.

With regard to module(s) 240e, as additional country specific data stores are added, the number of corresponding modules(s) 240e will increase as well to interface with these additional country specific data stores. These country specific data stores may also interface with automated or crowd-sourced language translation services.

IPXI module 240f is configured to interface with the IPXI data store which provides an exchange where IP owners can buy, sell, and/or license intellectual property assets.

The one or more additional modules 240g are monitoring adapter interfaces that enables developers to create a new patent notification executable code that can monitor new data stores that become available or are developed such as, for example, any new type of patent-related data sources that are developed.

A-PENS 130 further includes a client configuration matching agent 245 that is configured to match a patent that is granted by a monitored data store (e.g., USPTO or EPO) or patent application that is published by a monitored data store with any patent(s) or patent application(s), family or families of patent(s) or patent applications, and/or class or classes of patent(s) or patent application that are of interest to entity 102 or with another value in the client profile in database 215.

As an example, a user 102 can enter an associated name of an entity (e.g., a company named “company-X”) into web UI 205 or command line UI 210 or Application UI 280. Client configuration matching agent 245 will perform the following functions: (1) automatically find in patent database 235 all patent applications and patents owned by the company-X, (2) automatically identify key industries and technology areas of interest to company-X, (3) automatically find any patent applications or granted patents that reference the patents or published patent applications of company-X, and (4) notify company-X when a patent application(s) of interest and/or granted patent(s) of interest reaches (or will reach) a key milestone (such as, for example, an upcoming Post Grant Challenge deadline, an expiration of a granted patent, and/or the like). Patents Events that occurred prior to the configuration date will be historically mined and placed into the client's Client Notification Data Database 290 so the client can view historical reports for their configured patent event notifications. Any patent event data that has been placed into the client's notification data DB 290 will not need to go through the Notification API 250.

In an aspect, matching agent 245 is configured to match patents of interest and/or patent applications of interest to an entity 102 with content in patent database 235, and is configured to generate a Notification Event 252 if any match is found in database 235. Agent 245 sends a Notification Event 252, via a notification API 250, to a communications module 255 that communicates with a device 104 of entity 102. For example, a module 255 can be an email module 255a, short messaging service (SMS) module 255b, instant messaging module 255c, another type of communications module 255d for sending email messages, SMS messages, instant messages, or another type of message, respectively, to a client device(s) 104.

In an aspect of the invention, notification API 250 enables developers to create new notification mechanisms as new notification methods become available and module 255d can be a new module that includes a new notification mechanism.

In an aspect of the invention, after an entity 102 receives a notification event 252 concerning a granted patent of interest, the entity may choose to submit their own custom petition (e.g., Post Grant Challenge petition to a granted patent), may choose to review the granted patent associated with notification event 252 (including review of analytics or other data of other patents being challenged), and/or may choose to review analytics or other data regarding claim trends of granted patents.

In an aspect of the invention, after an entity 102 receives a notification event 252 concerning a granted patent of interest, the entity may choose to file a Post Grant Challenge petition and invite another party (or parties) or entity (or entities) to join in the petition. These other parties may be, for example, other entities who have been notified of the same granted patent and/or other entities known to the notified entity.

In an aspect of the invention, after an entity 102 receives a notification event 252 concerning a granted patent of interest, the entity may choose to file a Post Grant Challenge petition and also notify a virtual community that the entity is filing (or will be filing) a challenge petition. In an aspect, crowdsource system 131 is configured to allow entity 102 to notify a virtual community that a petition is being filed or will be filed. After an entity (e.g., entity 102a) is notified via a notification event 252 concerning a granted patent of interest, crowdsource system 131 also enables entity 102a to join a virtual network of other entities (e.g., entities 102b and 102c) who have also been notified via a notification event concerning a granted patent (or published application).

In an aspect of the invention, A-PENS 130 includes an automatic petitions submission module 260 that would verify each claim (in the granted patent in question) is mentioned in a petition and that would generate an editable petition form 265. An entity 102 can fill out the form that will embody the petition and module 260 will automatically send the petition to an appropriate government office 270 such as, for example, the U.S. Patent and Trademark Office with the appropriate payment drawn from a payment account 275 which is, for example, a bank or credit card account, a USPTO deposit account, or another type of payment account.

In an aspect of the invention, in the exceptions conditions where the automatic match does not work, A-PENS 130 will feed the exception(s) to crowdsource system 131 to validate the notification criteria for the claims. For example, an exception condition may be when a patent matches one or more configuration pattern matching settings, but does not match all conditions configured by the client.

FIG. 3 is a block diagram of a rule according to an aspect of the present invention. A user 102 can use web UI 205 or command line interface 210 or Application UI 280 to configure one or more rules 300. A rule 300 includes one or more of the following parameters: parameter 305 (which is associated with one or more patent data sources 241), parameter 310 (which is associated with one or more patterns which will be discussed below), parameter 315 (which is associated with one or more notification event stage indicating what type of “patent event” will occur for an entity that will receive a notification), parameter 320 (which is associated with one or more notification types 255), and/or parameter 325 (which is associated with one more recipients, i.e., one or more entities 102 to be notified). As discussed above, in an aspect, matching agent 235 may use a rule set 300 to determine if a granted patent or published patent is of interest to an entity 102. If so, then matching agent 235 will notify, via a notification event 252, a proper entity 102 about a patent of interest that has been granted or a patent application of interest that has been published.

FIG. 4 is block diagram of a one field value 400 according to an aspect of the present invention. In an example discussed above, a one field value 400 can be a company name 405 of an entity 102 such as “Company-X”, and matching agent 245 will perform the above-discussed matching functions to identify granted patents of interest to entity 102 or published patent applications of interest to entity 102.

In an aspect, one field value 400 may be other parameters such as, for example, an art unit 410 in the Examination Units in the USPTO, a class 415 for a patent application or patent, a family 420 for a patent application or patent, and/or another value 425. One field value 400 may also be a logical AND operation of at least two of parameters 405, 410, 415, 420, and 425.

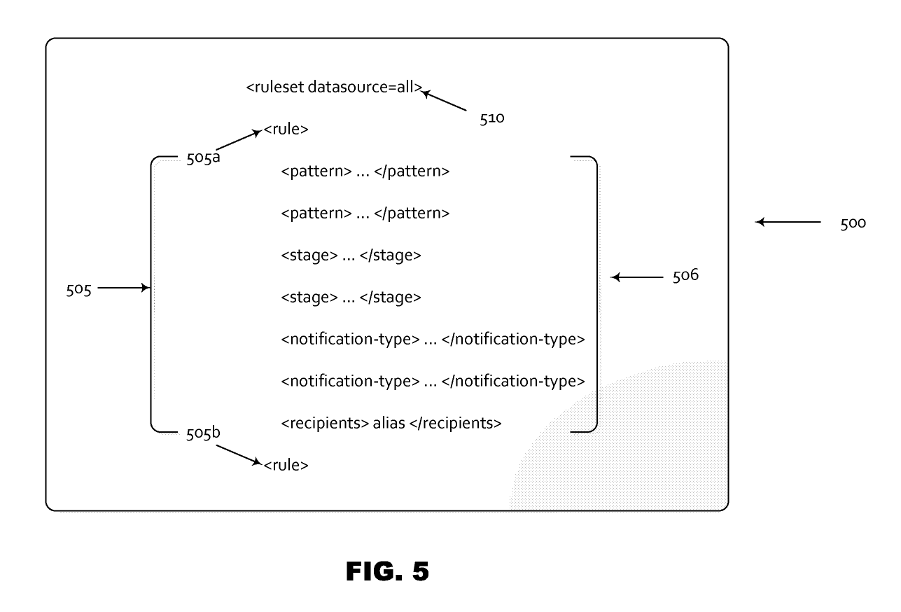

FIG. 5 is a block diagram of a rule set 500 according to an aspect of the present invention. A user 102 can use web UI 205 or command line interface 210 or Application UI 280 to configure one or more rule sets 500. Each rule set 500 includes one or more rules 505. In the example of FIG. 5, rule set 500 includes rules 505a and 505b. The details in fields 506 of a rule 505 were discussed previously above with reference to FIG. 3. Each rule set 500 can attach to one or more data source 241. When a rule set 500 is attached to a data source 241, then indexer 230 will monitor and search the attached data source 241 for patent events (e.g., patents of interest that grant and/or patent applications of interest that are published) and a client 102 that is noted as a recipient in a rule within rule set 500 will be notified by agent 245 of such a patent event. In the example of FIG. 3, rule set 500 attaches to all of data sources 241, as indicated in field 510. Therefore, indexer 230 will monitor and search all of data sources 241 for patent events.

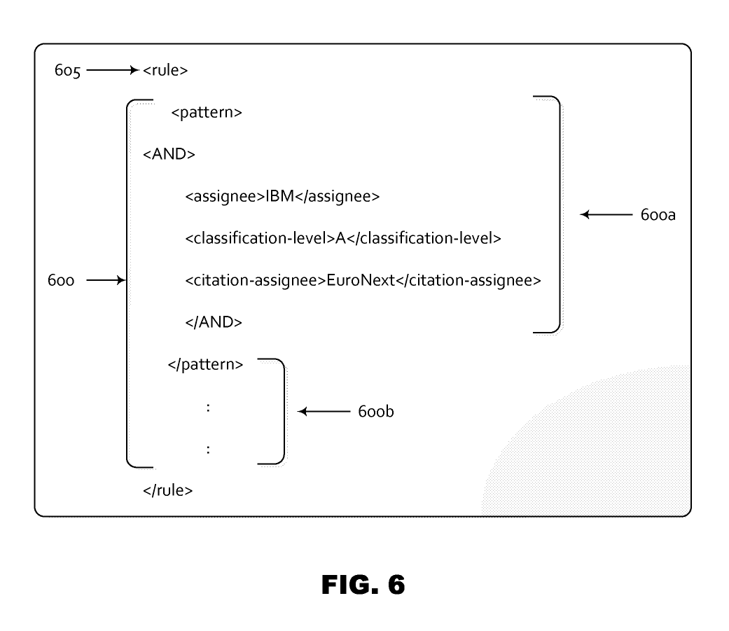

FIG. 6 is a block diagram of a pattern according to an aspect of the present invention. A pattern 600 (in a rule 605 of a rule set) is an API that returns a true or false condition and can be used to compose larger logical expression. In the example of FIG. 6, patterns 600 include a pattern 600a and a pattern 600b. Assembled pattern 600b imposes the rule requirement that indexer 230 will track and monitor, for an example entity (named Euronext), all IBM-owned (assigned) patents that are granted and that also refer to a Euronext-owned patent. Pattern 600b can impose other rule requirements desired by the same entity, Euronext, or desired by another entity.

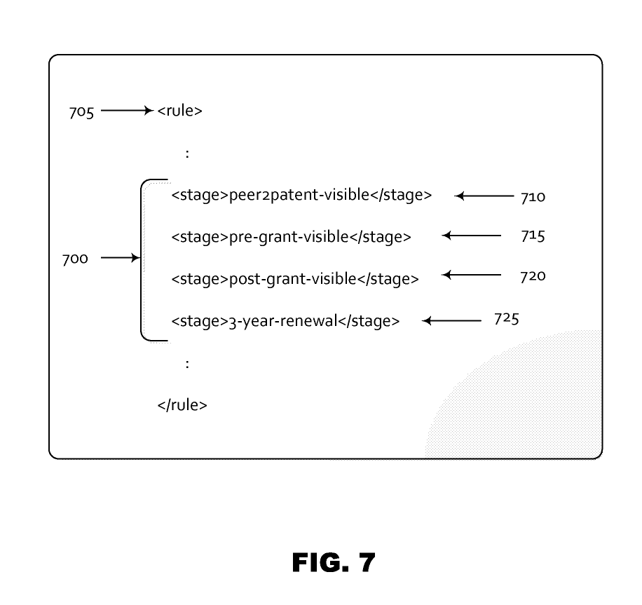

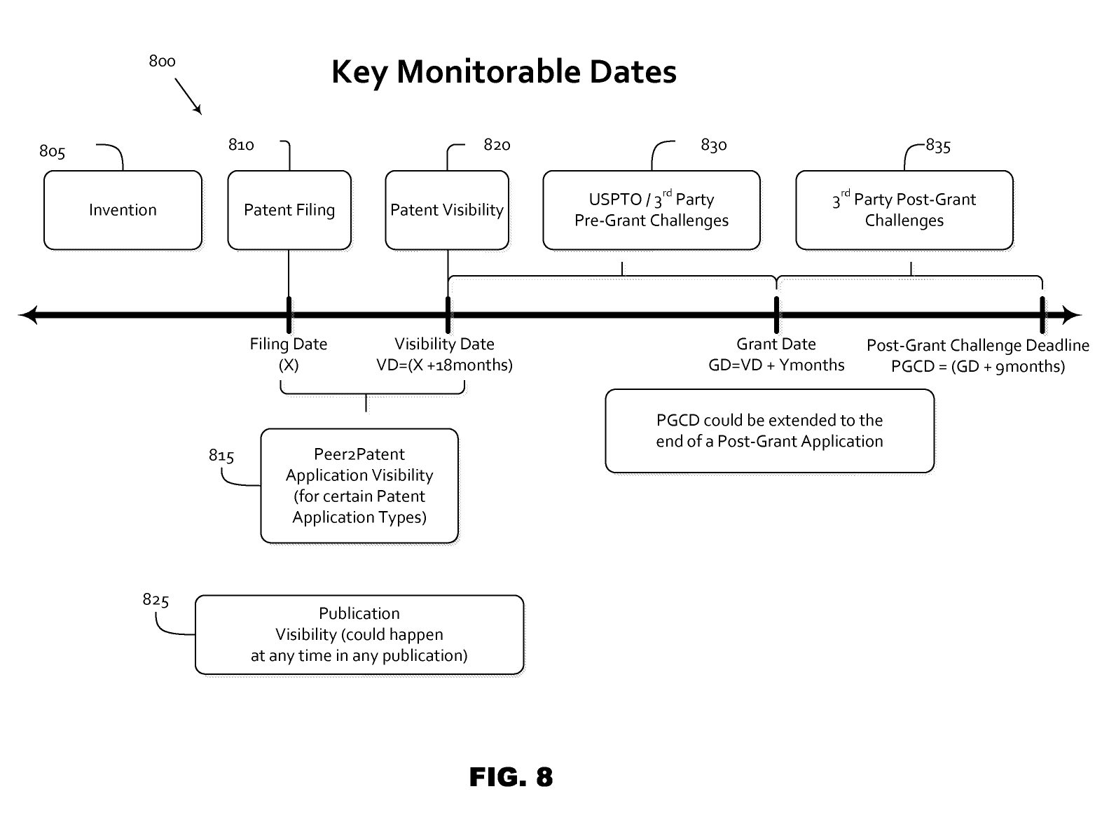

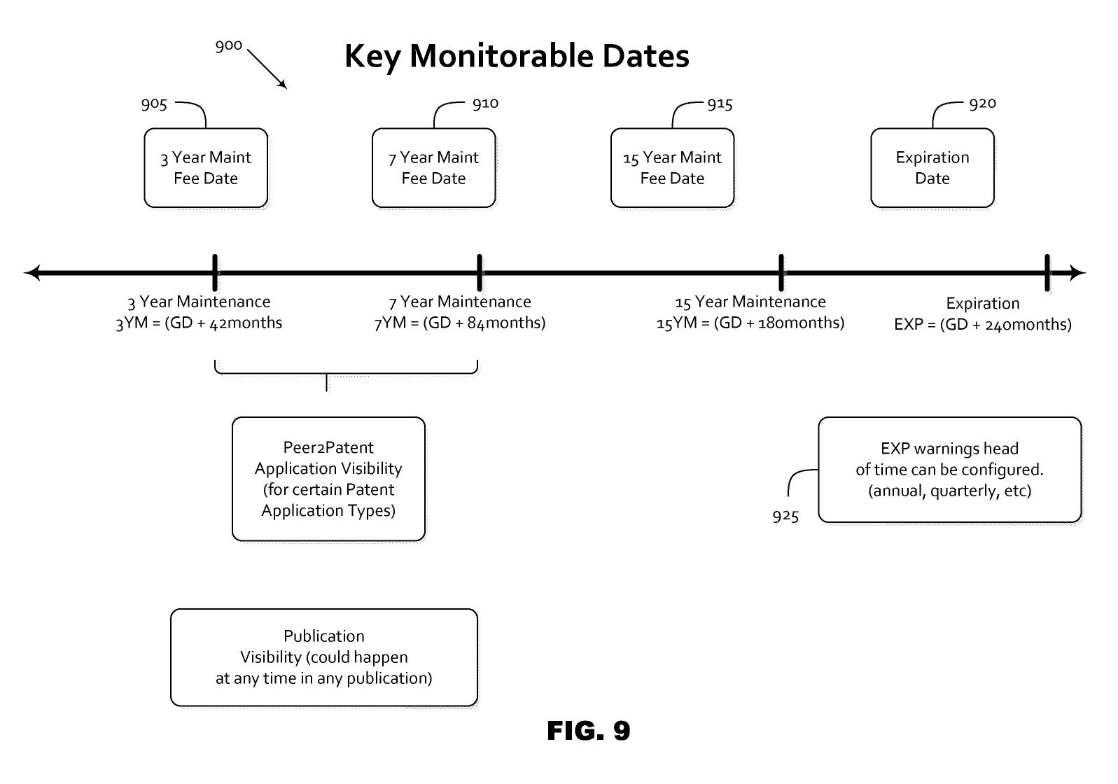

FIG. 7 is a block diagram of a rule event stage pattern according to an aspect of the present invention. A rule event stage pattern 700 (in a rule 705 within a rule set) is an API that allows a code developer to develop new patent stages that can be search and indexed. Patent stages are key monitorable dates for a patent or patent application as will be discussed with reference to FIG. 8 and FIG. 9. In the example of FIG. 7, pattern 700 imposes the rule requirement that indexer 230 will track and monitor, for a patent application of interest and/or patent of interest, when the patent application is visible (field 710), when the pre-grant patent application has publication visibility (field 715) during which third Party Pre-Grant Challenges can be made, when the patent is in the post-grant stage (field 720) during which third Party Post-Grant Challenges can be made, and when the patent is within but prior to the expiration of the 3-year renewal date (field 725).

FIG. 8 is a block diagram of a first set 800 of key monitorable dates that are monitored according to an aspect of the present invention. As discussed above, these monitorable dates can be programmed in a patent event stage pattern 700. When an invention 805 is disclosed in a patent application filing 810, visibility 815 of the patent application in Peer2Patent occurs for certain patent application types. The Patent Visibility date VD is when the patent application is visible 820 and occurs at any time 825 in a publication, usually 18 months after the filing date X. In the USPTO, a third Party Pre-Grant Challenge 830 may be initiated prior to the grant date GD, usually a Y number of months after the visibility date VD. A third Party Post-Grant Challenge 835 may be initiated by the Post-Grant Challenge Deadline PGCD at 9 months after the grant date GD.

FIG. 9 is a block diagram of a second set 900 of key monitorable dates that are monitored according to an aspect of the present invention. As discussed above, these monitorable dates can be programmed in a patent event stage pattern 700. The three-year maintenance fee date deadline 905 occurs 42 months after the grant date GD. The seven-year maintenance fee date deadline 910 occurs 84 months after the grant date GD. The fifteen-year maintenance fee date deadline 915 occurs 180 months after the grant date GD. The patent expiration date 920 occurs 2400 months after the grant date GD. Expiration warnings 925 prior to the expiration date 920 may be configured in stage pattern 700. These expiration warnings 925 may be transmitted to a recipient (i.e., an entity 102 to be notified) in an annual reminder, quarterly reminder, monthly reminder, or other reminder settings, as configured in stage pattern 700. In general, a new module can be added to handle any other Patent Office actions and their respective statutory/regulatory periods for applicant/patentee reply.

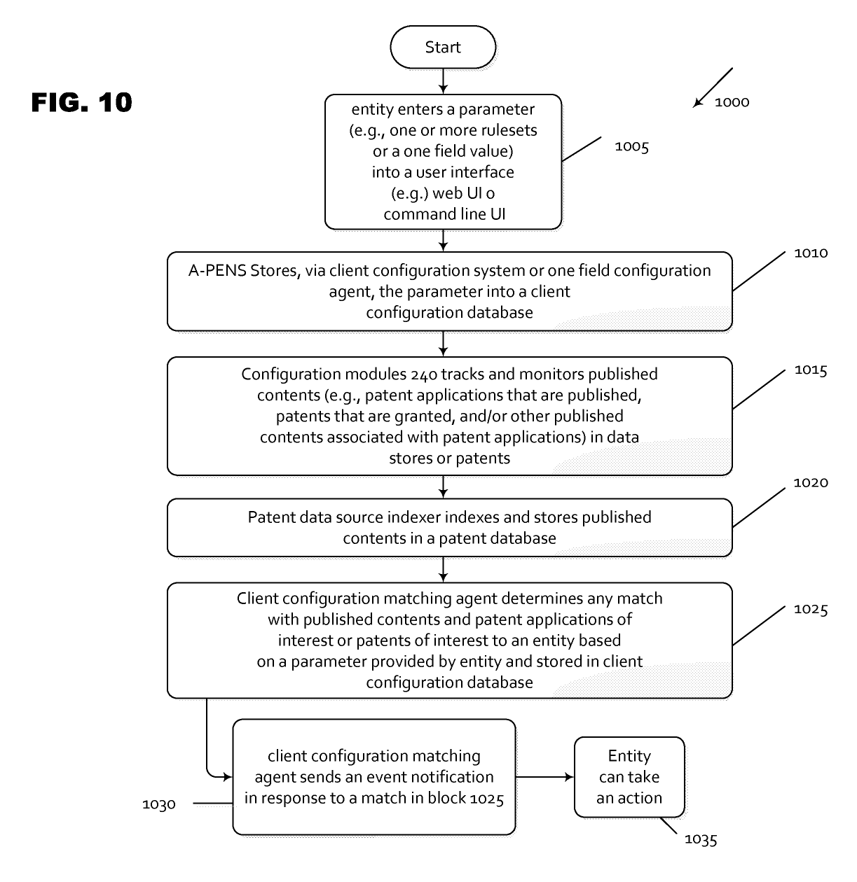

FIG. 10 is a flow diagram of an exemplary method 1000 for facilitating an automated patent event notification, according to an aspect of the present invention. In block 1005, an entity 102 enters a parameter (e.g., one or more rule sets or a one field value) into a user interface (e.g., web UI 205 or command line UI 210). The parameter identifies patent application(s) of interest or patent(s) of interest to entity 102.

In block 1010, A-PENS 130 stores, via client configuration system 220 or one field configuration agent 225, the parameter into a client configuration database 215.

In block 1015, configuration modules 240 tracks and monitors published contents (e.g., patent applications that are published, patents that are granted, and/or other published contents associated with patent applications or patents) in data stores 241

In block 1020, patent data source indexer 230 indexes and stores published contents in a patent database 235.

In block 1025, client configuration matching agent 245 determines any match with published contents and patent applications of interest or patents of interest to an entity 102 based on a parameter provided by entity and stored in client configuration database 215.

In block 1030, client configuration matching agent 245 sends an event notification 252 to entity in response to a match in block 1025. As a side effect, the matching agent will also store the event in the Client Notification Data Database, so the client can view reports of the historical notifications that they have received or are relevant to their configured patent event patterns.

In block 1035, entity 102 can take an action such as using a petition form 265 via automatic petition submission module 260 which automatically sends the petition to a government office, or can take other actions discussed above.

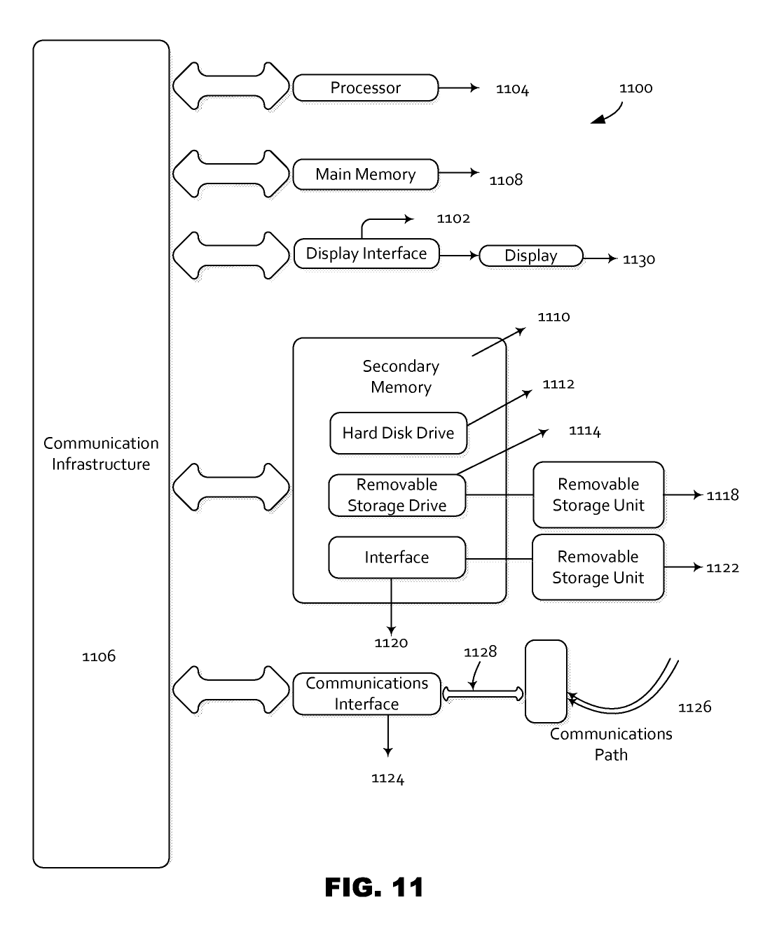

FIG. 11 is a block diagram of an exemplary computer system useful for implementing an aspect of the present invention. In one aspect, system 100 may be directed toward one or more computer systems capable of carrying out the functionality (e.g., process 1000 or the FIG. 2 functions) described herein. An example of a computer system 1100 is shown in FIG. 11. Computer system 1100 includes one or more processors, such as processor 1104. Processor 1104 may be connected to a communication infrastructure 1106, such as a communications bus or network, for example. Various software aspects are described in terms of this exemplary computer system. After reading this description, it will become apparent to a person skilled in the relevant art(s) how to implement the invention using other computer systems and/or architectures.

Computer system 1100 can include a display interface 1102 that forwards graphics, text and other data from communication infrastructure 1106, or from a frame buffer (not shown), for display via display unit 1130. Computer system 1100 may also include a main memory 1108, preferably a random access memory (RAM), and may further include a secondary memory 1110. Secondary memory 1110 may include, for example, a hard disk drive 1112 and/or a removable storage drive 1114, representing a floppy disk drive, a magnetic tape drive, or an optical disk drive, for example. Removable storage drive 1114 reads from and/or writes to a removable storage unit 1118 in a manner well known in the relevant art. Removable storage unit 1118 represents a floppy disk, magnetic tape, or an optical disk, which is read by and written to by removable storage drive 1114. As can be appreciated, removable storage unit 1118 includes a computer usable storage medium having stored therein computer software and/or data.

In alternative aspects, secondary memory 1110 may include other similar devices for allowing computer programs or other instructions to be loaded into computer system 1100. Such devices may include, for example, a removable storage unit 1122 and an interface 1120. Examples of such may include a program cartridge and cartridge interface, such as may be found in video game devices, a removable memory chip, such as an erasable programmable read only memory (EPROM), or programmable read only memory (PROM), and associated socket and other removable storage units 1122 and interfaces 1120, which allow software and data to be transferred from the removable storage unit 1122 to computer system 1100.

Computer system 1100 may also include a communications interface 1124. Communications interface 1124 allows software and data to be transferred between computer system 1100 and external devices. Examples of a communications interface 1124 may include a modem, a network interface such as an Ethernet card, a communications port, and a Personal Computer Memory Card International Association (PCMCIA) slot and card. Software and data transferred via communications interface 1124 are in the form of non-transitory signals 1128 which may be electronic, electromagnetic, optical or other signals capable of being received by communications interface 1124. Signals 1128 may be provided to communications interface 1124 via a communications path or channel 1126. Channel 1126 may carry signals 1128 and may be implemented using wire or cable, fiber optics, a telephone line, a cellular link, a radio frequency (RF) link, and other communications channels.

In this document, the terms “computer program medium” and “computer usable medium” are used to generally refer to media such as removable storage drive 1114, a hard disk installed in hard disk drive 1112, and signals 1128. These computer program products provide software to computer system 1100, wherein the present invention is directed to such computer program products.

Computer programs (also referred to as computer control logic), may be stored in main memory 1108 and/or secondary memory 1110. Computer programs may also be received via communications interface 1124. Such computer programs, when executed, enable computer system 1100 to perform the features of the present invention, as discussed herein. In particular, the computer programs, when executed, enable processor 1104 to perform the features of the present invention. Accordingly, such computer programs represent controllers of the computer system 1100.

In an aspect where the invention is implemented using software, the software may be stored in a computer program product and loaded into computer system 1100 using removable storage drive 1114, hard drive 1112 or communications interface 1124. The control logic (software), when executed by processor 1104, causes processor 1104 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown herein in various drawings may be configured as a desktop, a laptop, a server, a tablet computer, a PDA, a mobile computer, an intelligent communications device or the like. In yet another aspect, the invention may be implemented using a combination of both hardware and software.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A computer-implemented method for automatically notifying a user of a patent event having been performed by an organization, the method comprising:
(a) providing a graphical user interface (GUI) to a user via a network server;
(b) receiving, via said GUI, an input from said user, wherein said input is indicative of identifying a patent of interest said user desires to monitor;
(c) monitoring said organization for said patent event;
(d) sending notifications to said user, via said GUI, if said organization performs said patent event relating to said patent of interest; and
(e) providing, via said GUI, notifications that said user should perform an action, wherein said action relates to said patent event.

2. The computer-implemented method of claim 1, wherein said patent of interest is determined by at least one rule set.

3. The computer-implemented method of claim 2, wherein said at least one rule set comprises of at least one parameter.

4. The computer-implemented method of claim 2, wherein each said rule set enables said user to receive notifications on at least one said patent of interest.

5. The computer-implemented method of claim 2, wherein each rule set will be stored in a configuration database.

6. The computer-implemented method of claim 1, wherein a configuration module accesses said organization to monitor for said patent event, wherein said organization maintains an event database related to said patent of interest.

7. The computer-implemented method of claim 6, wherein a configuration matching agent identifies matches between said patent event in said event database and said at least one rule set in said configuration database.

8. The computer-implemented method of claim 1, wherein a notification database stores said notifications.

9. A computer system for facilitating the notification of a user about a patent event having been performed by an organization, comprising:
(a) a user interface configured to accept at least one rule set of a user, wherein said at least one rule set identifies a patent of interest;
(b) a configuration database configured to store the said at least one rule set;
(c) a configuration module configured to track and monitor for a patent event, wherein said organization maintains an event database related to said patent of interest;
(d) a configuration matching agent configured to identify matches between said patent event in said event database and said at least one rule set in said configuration database.

10. The computer system in claim 9, wherein said at least one rule set comprises at least one parameter.

11. The computer system in claim 9, wherein said configuration matching agent notifies said user in response to a match between said patent event in said event database and said at least one rule set in said configuration database.

12. The computer system in claim 9, further comprising a notification database configured to store said notifications.

13. A computer program product comprising computer usable medium encoded in a computer having control logic stored therein for causing the computer to automatically notify a user of an event having been performed by an organization, said control logic comprising:
(a) first computer readable program code means for causing the computer to provide a graphical user interface (GUI) to a user via a network server;
(b) second computer readable program code means for causing the computer to receive, via said GUI, an input from said user, wherein said input is indicative of a patent of interest said user desires to monitor;
(c) third computer readable program code means for causing the computer to monitor said organization for said patent event;
(d) fourth computer readable program code means for causing the computer to notify said user, via said GUI, if said organization performs said patent event on said patent of interest;
(e) fifth computer readable program code means for providing, via said GUI, notifications that said user should perform an action, wherein said action relates to said patent event.

14. The computer program product of claim 13, wherein said second computer readable program code means comprises computer readable program code means for causing the computer to determine said patent of interest from at least one rule set.

15. The computer program product of claim 14, wherein said at least one rule set comprises at least one parameter.

16. The computer program product of claim 14, wherein said rule sets enables a first user to receive notifications on at least one said patent of interest.

17. The computer program product of claim 14, wherein each rule set will be stored in a configuration data base.

18. The computer program product of claim 13, wherein a configuration module accesses said organization to monitor for said patent event, wherein said organization maintains a database related to said patent of interest.

19. The computer program product of claim 18, wherein a configuration matching agent identifies matches between said patent event in said event database and said at least one rule set in said configuration database.

20. The computer program product of claim 13, wherein a notification database stores said notifications.
